(19) United States
(12) Patent Application Publication
(10) Pub. No.: US 2025/0316055 A1
(43) Pub. Date: Oct. 9, 2025

(54) IMAGE NORMALIZATION FOR MULTISPECTRAL FLUORESCENCE MICROSCOPY AND VIRTUAL STAINING

(71) Applicant: Verily Life Sciences LLC, Dallas, TX (US)

(72) Inventors: Tadayuki Yoshitake, Foster City, CA (US); Charles Santori, Palo Alto, CA (US)

(21) Appl. No.: 19/080,058

(22) Filed: Mar. 14, 2025

Related U.S. Application Data
(60) Provisional application No. 63/574,087, filed on Apr. 3, 2024.

(51) Int. Cl. G06V 10/72; G06V 10/774; G06V 20/69

(52) U.S. Cl. CPC G06V 10/72; G06V 10/774; G06V 20/69; G06V 2201/03

(57) ABSTRACT

Techniques for implementing image normalization for multispectral fluorescence microscopy and virtual staining are disclosed. In an example method, a computing device receives, from an imaging device of a first imaging device type, a first autofluorescence image of a first tissue sample, the first autofluorescence image including one or more imaging channels. The computing device determines one or more normalization parameters for a first channel of the one or more imaging channels, the one or more normalization parameters for the first channel based on a first relationship between the first imaging device type and a second imaging device type, the second imaging device type being different from the first imaging device type. The computing device applies the one or more normalization parameters for the first channel to the first channel of the first autofluorescence image. The computing device outputs the normalized first channel of the first autofluorescence image.

### CROSS-REFERENCE TO RELATED APPLICATION

This application claims priority to provisional application U.S. Ser. No. 63/574,087 entitled “Image Normalization for Multispectral Fluorescence Microscopy and Virtual Staining” and filed on Apr. 3, 2024, the entire disclosure of which is incorporated herein by reference for any purpose.

### FIELD

The present application generally relates to machine learning in histology applications and more particularly relates to image normalization for multispectral fluorescence microscopy and virtual staining.

### BACKGROUND

Interpretation of tissue samples to determine the presence of certain disease (e.g., cancer) requires substantial training and experience with identifying features that may indicate cancer or other diseases. Typically, a pathologist will receive a slide containing a slice of tissue and examine the tissue to identify features such as biomarkers that may be used to diagnose the disease or indicate a type of treatment that may be effective on the disease. Staining techniques have been used to visualize different markers or structures within cells and tissues, which allows pathologists to classify cells, monitor cellular processes, and assess different diseases.

### SUMMARY

Various examples are described for image normalization for multispectral fluorescence microscopy and virtual staining. One example method includes receiving a first image of a first tissue sample, in which the first tissue sample is a first type of tissue sample from among a number of possible types of tissue samples and the first image includes one or more imaging channels; determining one or more normalization parameters for a first channel of the one or more imaging channels, the one or more normalization parameters for the first channel based on a first relationship between the first type of tissue sample and a second type of tissue sample, the second type of tissue sample being a different type of tissue sample than the first type of tissue sample; applying the one or more normalization parameters for the first channel to the first channel of the first image; and outputting the normalized first channel of the first image.

One example system includes a non-transitory computer-readable medium; one or more processors in communication with the non-transitory computer-readable medium, the one or more processors configured to execute processor-executable instructions stored in the non-transitory computer-readable medium configured to cause the one or more processors to receive a first image of a first tissue sample, in which the first tissue sample is a first type of tissue sample from among a number of possible types of tissue samples and the first image includes one or more imaging channels; determine one or more normalization parameters for a first channel of the one or more imaging channels, the one or more normalization parameters for the first channel based on a first relationship between the first type of tissue sample and a second type of tissue sample, the second type of tissue sample being a different type of tissue sample than the first type of tissue sample; apply the one or more normalization parameters for the first channel to the first channel of the first image; and output the normalized first channel of the first image.

One example non-transitory computer-readable medium including processor-executable instructions configured to cause one or more processors to receive a first image of a first tissue sample, in which the first tissue sample is a first type of tissue sample from among a number of possible types of tissue samples and the first image includes one or more imaging channels; determine one or more normalization parameters for a first channel of the one or more imaging channels, the one or more normalization parameters for the first channel based on a first relationship between the first type of tissue sample and a second type of tissue sample, the second type of tissue sample being a different type of tissue sample than the first type of tissue sample; apply the one or more normalization parameters for the first channel to the first channel of the first image; and output the normalized first channel of the first image.

Another example method includes receiving, from an imaging device of a first imaging device type, a first image of a first tissue sample, the first image including one or more imaging channels; determining one or more normalization parameters for a first channel of the one or more imaging channels, the one or more normalization parameters for the first channel based on a first relationship between the first imaging device type and a second imaging device type, the second imaging device type being different from the first imaging device type; applying the one or more normalization parameters for the first channel to the first channel of the first image; and outputting the normalized first channel of the first image.

Another example system includes a non-transitory computer-readable medium; one or more processors in communication with the non-transitory computer-readable medium, the one or more processors configured to execute processor-executable instructions stored in the non-transitory computer-readable medium configured to cause the one or more processors to receive, from a first imaging device type, a first image of a first tissue sample, the first image including one or more imaging channels; determine one or more normalization parameters for a first channel of the one or more imaging channels, the one or more normalization parameters for the first channel based on a first relationship between the first imaging device type and a second imaging device type, the second imaging device type being different from the first imaging device type; apply the one or more normalization parameters for the first channel to the first channel of the first image; and output the normalized first channel of the first image.

Another example non-transitory computer-readable medium including processor-executable instructions configured to cause one or more processors to receive, from a first imaging device type, a first image of a first tissue sample, the first image including one or more imaging channels; determine one or more normalization parameters for a first channel of the one or more imaging channels, the one or more normalization parameters for the first channel based on a first relationship between the first imaging device type and a second imaging device type, the second imaging device type being different from the first imaging device type; apply the one or more normalization parameters for the first channel to the first channel of the first image; and output the normalized first channel of the first image.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that implements image normalization for multispectral fluorescence microscopy and virtual staining, according to some aspects of the present disclosure.

FIG. 2 shows a simplified diagram of an example of a system implementing image normalization for multispectral fluorescence microscopy and virtual staining, according to some aspects of the present disclosure.

FIG. 3 shows another simplified diagram of an example of a system implementing image normalization for multispectral fluorescence microscopy and virtual staining, according to some other aspects of the present disclosure.

FIGS. 4A and 4B show sketches of example images of tissue samples that are unnormalized and normalized, respectively, according to some aspects of the present disclosure.

FIG. 5 shows an example method illustrating image normalization for multispectral fluorescence microscopy and virtual staining during inference using, according to some aspects of the present disclosure.

FIG. 6 shows an example method illustrating image normalization for multispectral fluorescence microscopy and virtual staining during inference, according to some aspects of the present disclosure.

FIG. 7 shows an example computing device suitable for use in example systems or methods for image normalization for multispectral fluorescence microscopy and virtual staining, according to some aspects of the present disclosure.

### DETAILED DESCRIPTION

Examples are described herein in the context of image normalization for multispectral fluorescence microscopy and virtual staining. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Some pathology workflows involve applying stains to tissue samples sections during preparation of slides for examination under a microscope. For example, a stain may be applied to each section of a sectioned tissue sample, resulting in an array of stained tissue samples. Examples of stains needed for various diagnoses include Hematoxylin and Eosin (H&E), Masson's Trichrome, P504S/AMACR/CK5 (PIN4), Immunofluorescence (IF), and Immunohistochemistry (IHC) stains. The stained slides can be examined under standard optical microscopes or fluorescent microscopes to enable histopathological evaluation.

For some applications, particularly in research, there may be insufficient tissue available for all of the desired stains. For example, a given sectioned tissue sample may yield only a small, finite number of sections for staining and evaluation. Tissue samples may be rare and expensive. As a result, research requiring a large number of stained sections and/or stain types for analysis may be prohibitively expensive or difficult to complete in the absence of adequate statistical confidence.

Additionally, the cost of the stains themselves, associated reagents, or labor increases as the requirement for more stained slides increases. One approach to reducing such costs and mitigating scarcity involves virtual staining. Virtual staining and related technologies can increase the information that can be obtained from a single, unstained tissue section. One example of a process involving virtual staining involves a multispectral fluorescence image obtained from an unstained tissue sample section, in which the autofluorescence of the unstained section is used to generate an autofluorescence image which may be a composite image of images of one or more imaging channels. A trained machine learning (ML)-based model is then used to generate a predicted image of a stained tissue sample that would be produced by a desired set of stains based on the autofluorescence data, referred to herein as a virtual stain prediction. The virtual stain prediction may be, for example, a greyscale image or conventional 3-color image, reflecting a single imaging channel. In some examples, the virtual stain prediction is a composite image reflecting numerous histology stains. The tissue section is left unstained and largely unaltered, potentially affected only by negligible photobleaching or photo damage affects, and otherwise available for subsequent staining or other analyses.

One challenge faced by operators of virtual staining platforms relates to consistent data quality. For example, standard histopathological laboratory procedures typically rely on guidelines and quality control measures to ensure that tissue preparations, such as staining, do not compromise the histopathological assays. However, even with extensive effort, inconsistencies such as slide production quality or unwanted dependencies on site or tissue condition often affect the accuracy of such assays, in addition to inconsistencies in spatial resolution or image sharpness.

Tissue autofluorescence signal is even more sensitive to the inconsistencies in the tissue preparation process. Furthermore, quality control of the multispectral fluorescence microscopes used during virtual staining can be challenging due to the complexity of the opto-mechanical structures as compared with standard optical microscopes or fluorescence microscopes. For example, for standard optical microscopes or fluorescence microscopes, image post-processing can be used to fine tune the appearance of the resulting digital images in response to certain known inconsistencies. However, the images predicted by ML-based virtual staining platforms are nonlinear with respect to the source images and common, manual image post-processing may not be sufficient to mitigate the variation of autofluorescence signals resulting from inconsistencies due to differing tissue types, differing tissue processing methods, differing imaging modalities, and so on.

Expanding the training data used by the ML models used by virtual staining platforms to include a wide range of variations in tissue types, processing methods, imaging modalities, etc. can mitigate such inconsistencies to some degree but such expansions significantly increase the costs of the training data as well as the time and computational resources needed to train the ML models. Moreover, even with significantly expanded training data, it can remain difficult to address outliers (e.g. a rare organ type with a rare property or a non-standard tissue processing method) not anticipated by the training data.

Techniques for image normalization for multispectral fluorescence microscopy and virtual staining are disclosed to address these challenges. For example, a robust image normalization process optimized for multispectral fluorescence microscopy can be used in conjunction with an ML-based virtual stain prediction platform to improve the accuracy of virtual stain predictions for predicted images that have inconsistent autofluorescent image profiles as compared with the dataset used for ML model training.

In an example method, a computing device receives an image of a tissue sample. For example, the tissue sample can be obtained from a patient as part of a biological assay for diagnosis or analysis of a pathology. The tissue sample is a first type of tissue sample from among a number of possible types of tissue samples. In this context, tissue sample types refer generally to tissue samples obtained using different techniques. For example, tissue samples can be obtained using techniques such as needle biopsy, excisional biopsy, fine needle aspiration, and so on. Each technique can yield distinct characteristics when examined under a microscope because the method of tissue extraction and the inherent properties of the sampled tissue influence the size, shape, and structural integrity of the specimen. For instance, larger tools as used in excisional biopsy may remove larger, more comprehensive samples but can alter tissue structure. In contrast, finer tools as used in needle biopsies, may yield smaller, less invasive samples, preserving more of the tissue's original architecture while providing less context.

The received image can be an autofluorescence image that includes one or more imaging channels. An imaging channel in the received image refers generally to a specific wavelength range of light. For example, a particular imaging channel may include a wavelength range emitted by a fluorescent stain or due to autofluorescence in the tissue sample. Autofluorescence involves the emission of light from certain components of the sample itself, without the use of external stains or markers. In this context, the imaging channels may include channels for naturally occurring fluorophores which emit light in particular wavelength bands when excited by light of the corresponding excitation wavelength.

A virtual staining platform may use an ML model to generate a virtual stain prediction of a tissue sample image based on the autofluorescence image received from a fluorescence microscope. The ML model may be trained using tissue samples of the second type. The tissue samples used during training may include both autofluorescence images of tissue samples of the second type, prior to staining, and images of those tissue samples after being stained, obtained using a multispectral imager such as a conventional microscope. When tissue samples of the first type are similarly excited and produce an autofluorescence image, the ML model may output sub-optimal predictions due to variations between the images used to train the ML model and the autofluorescence image under analysis.

To mitigate this disparity, the computing device determines a set of normalization parameters for a channel from among the one or more imaging channels. The set of normalization parameters for the channel are determined based on a relationship between the first type of tissue sample and the second type of tissue sample used during training of the ML model. For example, the set of normalization parameters may be scalar coefficients that are determined based on foreground or background characteristics of images of the first and second tissue types.

The computing device applies the set of normalization parameters for the channel to the corresponding channel of the received autofluorescence image. For example, if the set of normalization parameters are scalar coefficients, each pixel in the selected channel of the autofluorescence image may be multiplied by a scalar coefficient or be offset by a constant scalar value. As a result, the intensity of the pixel values for the channel may be enhanced or diminished according to the magnitudes or signs of the associated coefficients.

The computing device then outputs the normalized channel of the autofluorescence image. For example, following the application of the set of normalization coefficients using a multiplication or addition operation as just described, the channel is normalized and can be output for analysis by the ML model to, for example, generate a virtual stain prediction. In some examples, images of normalized imaging channels may be combined to produce a composite image prior to analysis by the ML model.

The techniques disclosed herein constitute significant improvements to the technical field of fluorescence microscopy and histology using ML methods. Using existing techniques, the accuracy corrections that are possible using the normalization techniques disclosed herein could only be realized by training the ML model with adequate numbers of tissue samples for each possible tissue sample type. Aside from being cost- and time-prohibitive, the scope of ML model training is significantly larger, requiring proportionately more computational resources and time to complete training. Thus, computational resources are preserved through less ML model training.

In addition, application of the techniques disclosed herein is not limited to the disparity between different tissue sample types. Any categorical factor which can cause inconsistencies between tissue sample images and therefore inaccuracies with respect to the ML model predictions based on differences between the input tissue sample image and the images used to train the ML model can be corrected using these techniques. For instance, tissue sample images obtained using different types of fluorescence microscopes or even different specific microscopes may cause inconsistencies or inaccuracies. Such inconsistencies can be similarly corrected using the normalization methods described herein.

The use of normalization parameters to correct inconsistencies can consume less computational resources than other techniques used in some existing systems. For example, normalization may involve straightforward arithmetic operations such as scaling (e.g., multiplication) or offsetting (e.g., addition) which may be computationally less expensive compared with some existing techniques that rely on machine learning algorithms or advanced filtering methods. Computational resources and labor are preserved through lessened need for image post-processing to correct known inconsistencies.

The techniques disclosed herein may also lead to improved outcomes for the patients providing the tissue samples. Because the virtual stain predictions are more accurate when used in conjunction with the normalization techniques disclosed herein, the resulting assays (e.g., diagnosis) may be accordingly more accurate or more precise.

This illustrative example is given to introduce the reader to the general subject matter discussed herein and the disclosure is not limited to this example. The following sections describe various additional non-limiting examples illustrating techniques for image normalization for multispectral fluorescence microscopy and virtual staining.

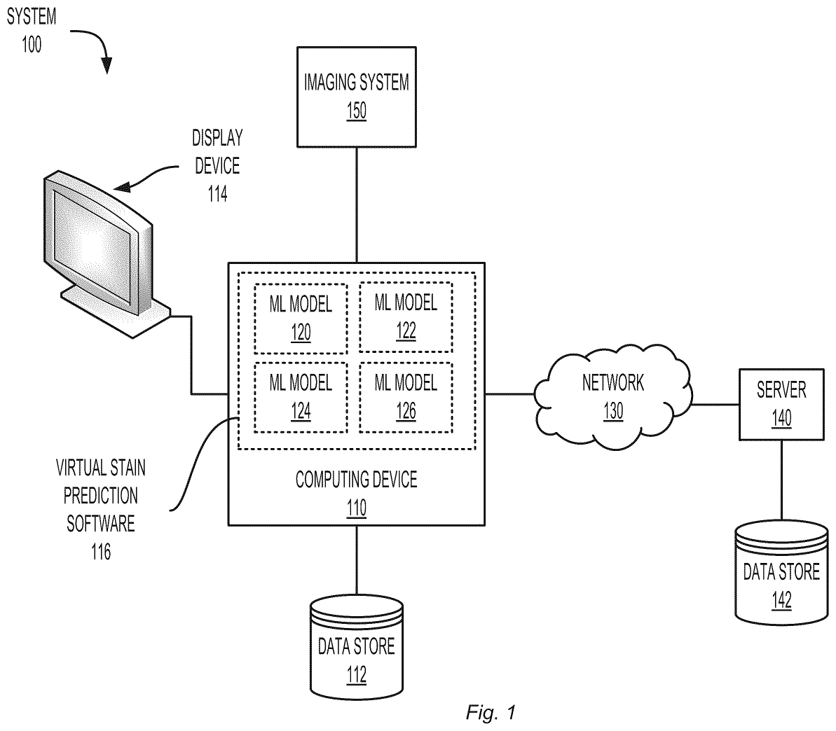

Referring now to FIG. 1, FIG. 1 shows an example system 100 that implements image normalization for multispectral fluorescence microscopy and virtual staining. The system 100 includes an imaging system 150 that is connected to a computing device 110. The computing device 110 has virtual stain prediction software 116, which includes multiple ML models 120-126 stored in memory for generating virtual stain predictions, and is connected to an imaging system 150, a display device 114, a local data store 112, and to a remote server 140 via one or more communication networks 130. The remote server 140 is, in turn, connected to its own data store 142.

The multiple ML models 120-126 in the virtual stain prediction software 116 can be trained and provided by the remote server 140. The ML models 120, 122, 124, and 126 are just examples of trained ML models. There can be less than four trained ML models or more than four trained ML models in the virtual stain generation software 116.

The remote server 140 can train an ML model and provide one or more trained ML models for generating virtual stain predictions of one or more stain types. In some examples, the remote server 140 accesses training data including one or more sets of unstained (e.g., autofluorescence) or stained images of a particular tissue type or other unifying characteristic (e.g., stained images obtained using a particular imaging device type or under certain conditions). In some examples, the training data may include sets of unstained or stained images of another tissue type. In that case, the respective sets of stained images can be used to train ML models for use under different circumstances, according to the tissue type used during inference.

The remote server can train an ML model using the training data to obtain one or more trained ML models for generating images of virtual stain predictions based on one or more stain types. While the process of training an ML model occurs on the remote server 140, in some examples, a third-party provider (not shown) can train ML models for generating virtual stain predictions. In this case, the third-party provider trains ML models for generating different types of virtual stain predictions for different tissue types and provides trained ML models to the remote server 140, which can then provide the trained ML models to the computing device 110.

The imaging system 150 includes a microscope and camera to capture images of pathology samples. Imaging system 150 in this example is a conventional pathology imaging system that can capture digital images of tissue samples, stained or unstained, using broad-spectrum visible light. The imaging system 150 can include (for example) a microscope (e.g., a light microscope) and/or a camera. In some instances, the camera is integrated within the microscope and the microscope can include a stage on which the portion of the sample (e.g., a slice mounted onto a slide) is placed, one or more lenses (e.g., one or more objective lenses and/or an eyepiece lens), one or more focuses, and/or a light source. The camera may be positioned such that a lens of the camera is adjacent to the eyepiece lens. In some instances, a lens of the camera is included within image collection system 104 in lieu of an eyepiece lens of a microscope. The camera can include one or more lenses, one or more focuses, one or more shutters, and/or a light source (e.g., a flash). The digital images from the imaging system 150 can be conventional stained images, images generated by fluorescence, or autofluorescence images. Alternatively, the imaging system 150 can implement other suitable imaging techniques.

The tissue samples can include, but are not limited to, a sample collected via a biopsy (such as a core-needle biopsy), fine needle aspirate, surgical resection, or the like. In one scenario, a tissue sample can be prepared for imaging within the conventional imaging system 150, such as by obtaining one or more thin slices of tissue taken from a patient, and positioning them on corresponding slides, which are then inserted in sequence into the imaging system 150. The imaging system 150 then captures images of unstained samples and provides them to the computing device 110. A set of unstained images may be then generated by the imaging system 150 and each image of the set of images may correspond to different portions of the biological sample.

The computing device 110 receives digital autofluorescence images from the imaging system 150 corresponding to a particular tissue sample and provides them to one of the ML models 120-126 to generate a corresponding virtual stain prediction of a tissue sample. After receiving the captured unstained image or multiple captured unstained images, the computing device 110 may store the image(s) in the local data store 112. It then executes the virtual stain prediction software 116 on an image for a particular biological sample. A set of virtually stained images may then be generated by the virtual stain generation software 116 and each image of the set of virtually stained images may correspond to different biological markers in a particular biological sample on a slide. The virtually stained images can be displayed via a display device 114.

While in this example, the entire process occurs on the local computing device 110 and imaging system 150, such an arrangement is not needed. For example, an example system may omit the imaging system 150. Instead, the computing device 110 could obtain autofluorescence images or optical/light images of stained slides from the local data store 112 or from the remote server 140. Alternatively, while virtual stain prediction software 116 is executed at the computing device 110, in some examples, the whole slide images may be provided to the remote server 140, which may execute virtual stain prediction software 116, including suitable ML models, e.g., ML models 120-126. Thus, the system shown in FIG. 1 may, according to different examples, provide virtual stain predictions in settings having suitable imaging devices or by receiving images of pathology tissue from a third party for processing, including in a cloud environment provided by a remote server 140.

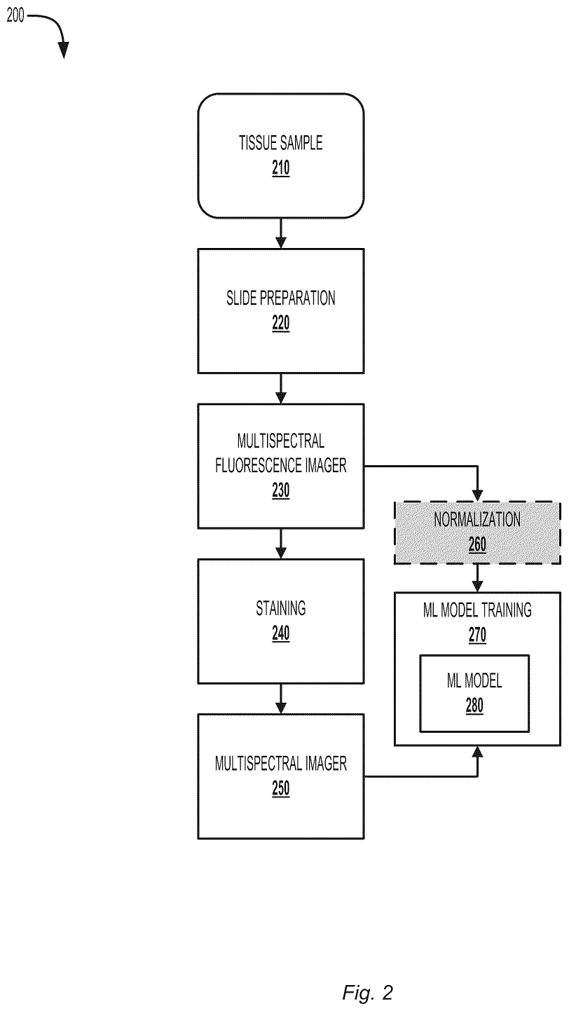

Turning now to FIG. 2, FIG. 2 shows a simplified diagram of an example of a system 200 implementing image normalization for multispectral fluorescence microscopy and virtual staining. In particular, system 200 depicts components configured for training an ML model 280. In some examples of configurations of system 200, a normalization component 260 is used during ML model training to improve the accuracy of the virtual stain predictions and mitigate inconsistencies among tissue sample types, imaging devices, and so on.

The system 200 receives a tissue sample 210. The tissue sample 210 can be obtained from a human or animal subject using a variety of techniques. The tissue sample 210 may be obtained from the human or animal subject to evaluate a pathology, determine a treatment plan, for research purposes, or for any other suitable purpose.

The particular technique used to obtain the tissue sample 210 determines the tissue sample type. For example, the tissue sample 210 may be obtained using techniques such as a needle biopsy, an excisional biopsy, a fine needle aspiration, and so on. Such techniques or groupings thereof, correspond to tissue sample types that system 200 is configured to receive.

The same subject tissue obtained using different techniques can result in different characteristics when sectioned and imaged. For example, a needle biopsy may provide small, cylindrical samples. A tissue sample obtained through fine needle aspiration can yield small, scattered clusters of cells rather than an intact tissue architecture. As a result, the size, shape, or structural integrity of the tissue sample 210 may depend on the technique used to obtain it and can cause significant variation in the resultant image. Consequently, existing systems may only use one or a limited number of tissue sample types to train ML models used for virtual stain predictions.

The system 200 includes a slide preparation component 220. The tissue sample 210 can be prepared using standard slide preparation techniques such as de-hydration, paraffinization, and sectioning. For example, de-hydration may involve removing water from the tissue sample 210 using chemical or mechanical methods. Paraffinization can involve adding a medium such as paraffin wax to the dried tissue sample 210 to allow for thin sectioning without distortion or damage. Sectioning may involve slicing the tissue sample 210 into thin slices a few micrometers thick. The thus-prepared sections can be placed on slides for staining (during ML model 280 training) and microscopic examination or for exciting to generate autofluorescence images.

In addition to the slide preparation processes performed by slide preparation component 220, additional aspects of tissue preparation such as tissue storage time or initial tissue condition (e.g., the time between tissue biopsy and resection or fixation) can affect the resulting images obtained as described below. For instance, the slide preparation processes performed by slide preparation component 220 can vary significantly among and between systems. As a result, different processes or methods for tissue preparation or slide preparation, individually or in combination, can constitute different tissue sample types.

Aspects of slide preparation techniques or tissue preparation that may impact fluorescent emission intensities or spectra can include section thickness, such as the thickness of the tissue sample. Other example aspects may involve the Formalin-Fixed Paraffin-Embedded (FFPE) fixation protocol, an example tissue preservation method. In this example, the formalin fixation can reduce fluorescence in nicotinamide adenine dinucleotide (NADH), which can be a significant component of the fluorescence signal in non-fixed tissue. Other example aspects may include patient characteristics such as the age or smoking status associated with a given tissue sample.

The system 200 includes a multispectral fluorescence imager 230. Multispectral fluorescence imaging involves capturing images at multiple wavelengths of light, including light beyond the visible spectrum. Coupled with the fluorescent properties of the sectioned tissue samples and/or stains, fluorescence microscopy involves capturing the fluorescent light emitted by excited tissue samples again at multiple wavelengths.

The multispectral fluorescence imager 230 can be used to capture images generated through autofluorescence. Autofluorescence refers to the natural emission of light by the unstained tissue sample 210 when excited with light of a particular wavelength. The images thus generated through autofluorescence can be used in conjunction with images of stained tissue sample sections to train the ML model 280, as described below.

The system 200 includes a staining component 240. The staining component 240 can apply stains to the sectioned tissue sample 210 to obtain a stained tissue sample 210 for use during training of the ML model 280. In the staining component 240 a manual immersion or automated staining processes is used to apply one or more stains to the tissue sample 210. Following application of the stain and a suitable period of time, excess stain is washed off, and the sample is mounted for microscopic examination. For instance, the now-stained tissue sample may be placed or replaced on a slide.

Various stains may be used, depending on the particular histological or research goals. The stains may be chosen based on the characteristics of the autofluorescent unstained tissue sample autofluorescence image obtained using the multispectral fluorescence imager 230. For instance, a hematoxylin and eosin (H&E) stain can be used to stain cell nuclei blue or purple. During training of the ML model 280, the ML model 280 can be trained to predict the fluorescence image that would be generated using an H&E stain by using the stained tissue sample 210 as training data for the ML model 280. Other stains commonly used for multispectral fluorescence microscopy and virtual staining include gram stain, periodic acid-schiff (PAS), Giemsa stain, or fluorescent stains (e.g., IF), such as fluorescein isothiocyanate (FITC) or rhodamine.

The system 200 includes multispectral imager 250. The multispectral imager 250 may be, for example, a brightfield or transmission microscope, an optical microscope (e.g., a slide scanner), or a multispectral fluorescence microscope. The multispectral imager 250 can be used as a conventional microscope to image the now-stained tissue sample 210. For example, non-fluorescent stains (e.g. H&E) can be scanned using a brightfield or transmission or an optical microscope. In other examples, fluorescent stains (e.g., IF) can be scanned using a conventional fluorescence microscope or a multispectral fluorescence microscope. The images thus obtained is used as part of the training data for the ML model 280 in conjunction with the autofluorescence images obtained using the multispectral fluorescence imager 230.

The system 200 includes an ML training component 270 that is used to train the ML model 280. The ML model 280 may be a deep learning model inspired by the pix2pix translation models and adversarial networks. The ML model 280 may include a translation model configured for image-to-image translation tasks. The translation model can be based on the pix2pix conditional generative adversarial network (cGAN) architecture. The translation model can include a generator with a U-Net-based architecture and a discriminator complex which may include three discriminators based on the Inception or Patch GAN architecture which operate at three different scales. The U-Net-based architecture refers to a number of machine-learning components configured for image segmentation, including a contracting subcomponent for context capture and an expanding subcomponent for precise localization utilizing convolutional neural networks (CNNs). An attention gate module can be added to the U-Net GAN to improve segmentation precision and target area distillation. The attention gate module can guide the U-Net model's attention to important regions while suppressing features in unrelated areas of a training image patch.

The generator can be trained with a combination of GAN and LI loss. The set of discriminators can operate at different scales of the image and be trained with least-squares loss. A custom shift variant loss and rotational consistency loss can also be applied. Hyperparameters can be experimentally determined based on a set of validation data.

This is one example of a possible implementation of the ML model 280. Other architectures and components may be used for the image-to-image translation task used during prediction of virtual stains. Alternative implementations may include autoencoders, variational autoencoders, transformer networks, other GAN implementations (e.g., CycleGAN, StyleGAN, etc.), recurrent neural networks (RNNs), residual networks (ResNets), and so on.

The ML training component 270 receives training data including at least two sets of images. The first set of images include autofluorescence images of tissue sample 210 obtained using multispectral fluorescence imager 230. The second set of images includes images of the same tissue sample 210, except now stained. The images in the second set are obtained using multispectral imager 250. The ML training component 270 can be configured to train the ML model 280 to “translate” the autofluorescent image to the stained image. The translated, predicted image is sometimes referred to as a virtual stain prediction or a prediction of a stained tissue sample image. As described above, the trained ML model 280 enables the accomplishment of histological or research goals with significantly reduced investments of time, costs, and consumption of available tissue samples.

However, often in existing systems, the ML model 280 is trained using tissue samples only of one or few tissue sample types. This may be due to practical considerations such as cost, time, labor, or availability of tissue samples obtained using other techniques. Once the ML model 280 is trained, however, it may be deployed in a variety of scenarios, including ones in which inference (e.g., prediction of a virtual stain) is desired when only tissue samples of a different type are available.

This challenge is not limited to variation in tissue sample types. In some other examples, the ML model 280 may be trained using images obtained using one type of imaging device while inference is performed using a different type of imaging device. Similar problems obtain during inference when the ML model 280 is trained using a specific imaging device, specific imaging device components, specific chemicals, stains, or reagents, trained under specific environmental conditions (e.g., temperature, humidity, etc.), and so on. In each of these cases, the conditions under which the ML model 280 is trained may affect the virtual stain predicted during inference. Some existing systems may even apply additional image processing or fine tuning of the predicting virtual stains in an effort to compensate for the poor accuracy resulting from these and other similar biases.

To mitigate these biases due to the particular circumstances of training the ML model 280, in some examples, the system 200 includes a normalization component 260. Normalization component 260 is shown shaded and with a dotted line to indicate that it may be included in system 200 in some examples. The normalization component 260 can apply one or more normalization parameters to the autofluorescence images used to the train the ML model 280. The normalization parameters may be, for example, scalar coefficients that are determined prior to or in parallel with training the ML model 280 by determining a relationship between images with one characteristic and images with a different, but related characteristic. For example, coefficients can be determined that relate one type of tissue sample to another type of tissue sample.

In a simple example, consider an ML model 280 that is trained using a first tissue sample type (e.g., biopsy, represented as type A) that will be used for inference using a second tissue sample type (e.g., aspiration, represented as type B). An autofluorescence image of an unstained tissue sample 210 of the first tissue sample type may be obtained using the multispectral fluorescence imager 230. The image may include one or more imaging channels. In this context, “imaging channels” refers to the different spectral ranges captured separately when imaging the autofluorescing tissue sample 210. Each channel represents a specific wavelength range corresponding to the emission spectra of different fluorophores in the tissue sample 210. A fluorophore is a fluorescent chemical compound that can re-emit light upon light excitation.

In this example, the autofluorescence image may be represented symbolically as RawImage. RawImage corresponds to an autofluorescence image of a tissue sample 210 with n imaging channels. RawImage(n) corresponds to the image of the nth imaging channel of tissue sample 210. The images used for training the ML model 280 by ML training component 270 can be generated using the normalization function represented by F(C_{AB}(n), RawImage(n)) for imaging channel n. The value C_{AB}(n) may be, for example a scalar, vector, matrix, or other suitable object for representing the normalization parameters. In this example, the value C_{AB}(n) is a two component vector that represents a scaling and an offset applied to RawImage(n). In this example, the function Fis given by F(C_{AB}(n), RawImage(n))=C_{AB}_{₁}(n). RawImage(n)+C_{AB}_{₂} (n). The coefficient C_{AB}_{₁}(n) multiplies the autofluorescence image of the tissue sample 210 for the nth channel while the coefficient C_{AB}_{₂}(n) adds an offset. The autofluorescence image of the tissue sample 210 thus normalized by normalization component 260 can be provided to the ML training component 270 to train the ML model 280 to predict virtual stains with improved accuracy and other benefits.

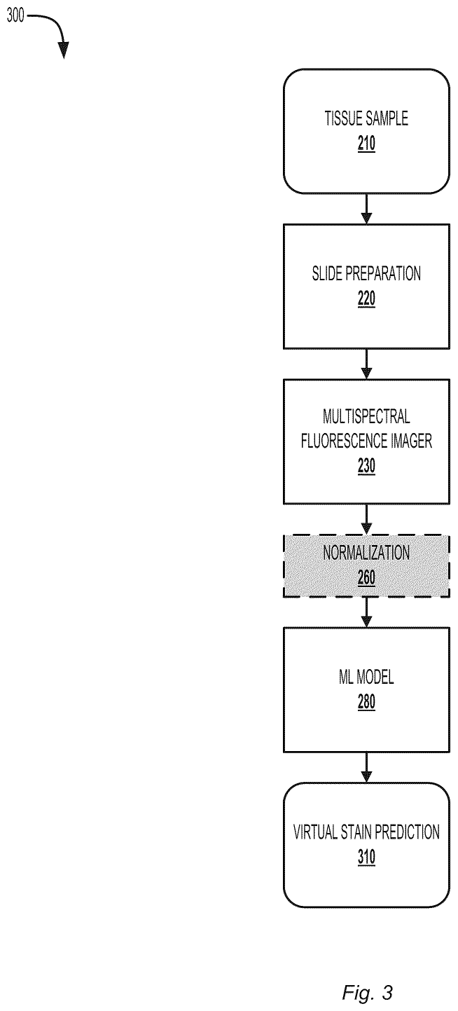

When the techniques of this disclosure are used for training the ML model 280 as described above, the resulting trained ML model 280 can be used for inference given normalized images of tissue samples of the designated type (e.g., type B in the example above). However, this approach requires the autofluorescence imaging data of those designated tissue types to be available for training the ML model 280. The techniques disclosed herein are useful because, among other things, tissue samples of the designated type may be scarce or expensive, training of an ML model 280 in this way may not be practical or feasible. In that case, use of normalization during inference, as described below with respect to FIG. 3 below may be a more effective choice. Additionally, as will be described, normalization can be performed both during training and inference.

In addition to differing tissue types, the normalization performed by normalization component 260 may be used to correct biases due to other characteristics of the autofluorescent images such as the imaging device or imaging device type. For example, in a simple example involving a particular tissue sample type, the training images may be captured using an imaging device of type A, while inference is desired using an imaging device of type B. The normalization function F (C_{AB}(n), RawImage(n)) can be used to correct the bias introduced by using a different imaging machine type, in analogy to the normalization procedure described above for tissue sample type. This approach to normalization is likewise applicable specific imaging devices, specific imaging device components, specific chemicals, stains, or reagents, trained under specific environmental conditions (e.g., temperature, humidity, etc.), and so on.

The techniques disclosed herein can be used for correction of multiple types of bias at once, using a suitable multi-dimensional normalization technique. For example, normalization parameters may be determined that include corrections for both tissue sample type and imaging device type. However, the quantity and diversity of training data required in this case can grow geometrically and may not be feasible or practical in some cases.

Turning now to FIG. 3, FIG. 3 shows a simplified diagram of an example of a system 300 implementing image normalization for multispectral fluorescence microscopy and virtual staining. In particular, system 200 depicts components configured for predicting a stained tissue sample image, sometimes referred to as virtual stain prediction. In some examples of configurations of system 300, a normalization component 260 is used during ML model 280 inference to improve the accuracy of the virtual stain predictions and mitigate inconsistencies among tissue sample types, imaging devices, and so on.

The components of system 300 are described above with respect to FIG. 2. The system 300 receives a tissue sample 210. The system 300 includes a slide preparation component 220, and a multispectral fluorescence imager 230. During inference, the autofluorescence image generated by multispectral fluorescence imager 230 is input to the trained ML model 280. The trained ML model 280 is configured to output virtual stain prediction 310 which may include a prediction of a stained tissue sample image. For example, the virtual stain prediction 310 may be a predicted image of what would have been output by a tissue sample stained with H&E and imaged with a conventional optical microscope.

Due to the challenges associated with inaccuracies due to inconsistencies between the images constituting the training data used to train ML model 280 and the images used during inference, the normalization component 260 may be used during inference. In that case, the images output by the multispectral fluorescence imager 230 are input to normalization component 260, again shown shaded and with a dotted line to indicate that it may be included in system 300 in some examples. The normalization component 260 can apply one or more normalization parameters to the autofluorescence images output by the multispectral fluorescence imager 230 prior to being input to the trained ML model 280 for inference of a virtual stain prediction 310. The normalization parameters may be, for example, scalar coefficients that are determined after training the ML model 280 by determining a relationship between images with one characteristic and images with a different, but related characteristic.

Systems 200 and 300 show examples of systems in which the normalization component 260 is used during training of the ML model 280 and during inference using the trained ML model 280, respectively. In some examples, the normalization component 260 or similar implementations thereof, can be used both during training of the ML model 280 and during inference using the trained ML model 280. The accuracy of the virtual stain prediction 310 may be further improved when normalization is applied to input images to the ML model 280 for training and for inference.

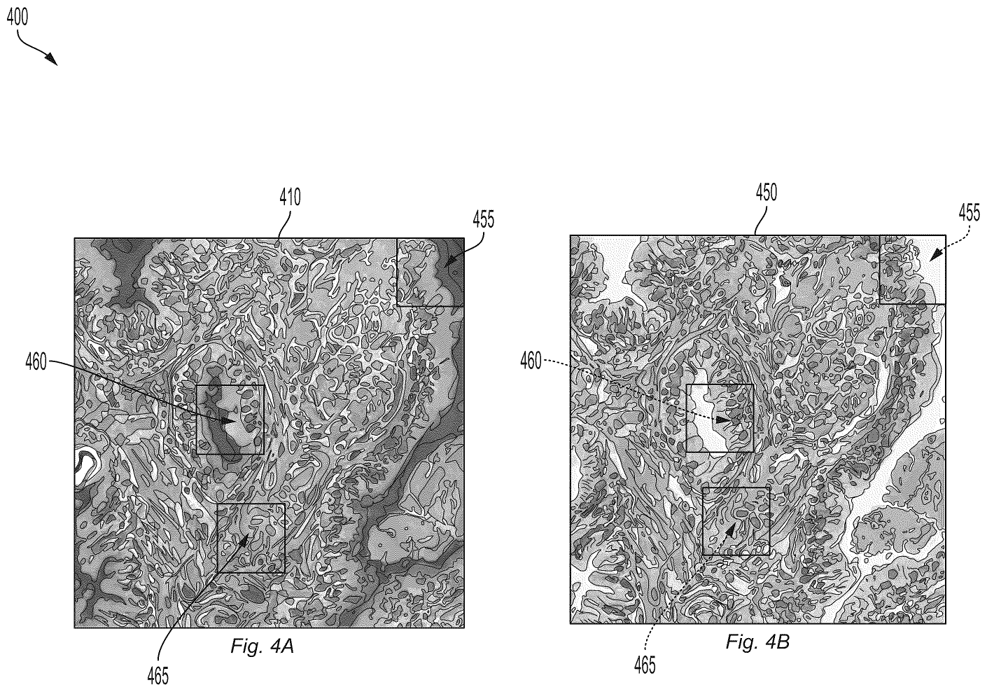

Turning next to FIGS. 4A and 4B, FIGS. 4A and 4B show sketches of example images of virtual stain predictions that are determined by an ML model. Virtual stain prediction 410 is based on an unnormalized (e.g., prior to normalization) autofluorescence image, whereas virtual stain prediction 450 is based on a normalized autofluorescence image. The contrast between predictions 410 and 450 illustrates a particular method of performing the normalization operation, but other methods may be chosen than result in a different contrast between virtual stain predictions based on unnormalized and normalized autofluorescence images.

In this example, the normalization function is generated to normalize virtual stain predictions for tissue samples of type B when the ML model 280 is trained using images of tissue samples of type A. In particular, the images of tissue samples of type A include both autofluorescence images of tissue samples of type A, prior to staining, and images of those same tissue samples of type A after being stained. The particular normalization can be chosen, for example, to equalize the mean and mean background images between the images of tissue samples of type A and B.

FIG. 4A shows an image of a virtual stain prediction 410 based on an autofluorescence image of tissue type B. In contrast, FIG. 4B shows a virtual stain prediction 450 for tissue type B, after applying an example of the normalization method of the present disclosure to the autofluorescence input image to ML model 280 to generate virtual stain prediction 450. FIGS. 4A-4B illustrate improvements to the image background 455, maintenance of important details following formalization such as nuclei distinctiveness 460, and corrections to nuclei color 465 (shown as shading in FIG. 4B). However, these are merely illustrative examples of the positive impacts of normalization intended to highlight certain examples. Normalization, as disclosed herein, can improve the substance and accuracy of virtual stain predictions in a large variety of ways.

An example normalization function can be chosen that equalizes the mean foreground and mean background pixel values between the autofluorescence images of unstained tissue samples of type A and B. The functional form F may be similar to the form described above with respect to FIG. 2:

F(C_{AB}(n),NormalizedInputImage(n))=C_{AB}_{₁}(n)·UnnormalizedInputImage(n)+C_{AB}_{₂}(n).

In this case, the two-element vector C_{AB}(n) includes normalization coefficients for scaling and offset. UnnormalizedInputImage and NormalizedInputImage refer to the unnormalized and normalized autofluorescence images of the unstained tissue sample prior to input to the ML model for inferring virtual stain predictions 410 and 450, respectively.

The coefficients can be determined, for example, during training of the ML model 280 when images of tissue samples of both types A and B are available. To determine the coefficients, the mean image of the collection of m tissue sample images of type A and spectral channel n can be determined. This can be represented symbolically as:

ImageMean_{A}=mean(ImageA₁,ImageA₂,ImageA₃, . . . ,ImageAₘ).

For example, the images can be averaged using a region-of-interest (“ROI”) method In an ROI method, an ROI can be manually or algorithmically defined for each image. For instance, the defined ROIs may be an image for a spectral channel, a selected area within the image for a spectral channel, a composite image (e.g., combined images for two or more spectral channels), or selected area in the composite image In some examples, ROIs may be defined or modified to exclude regions not including tissue or other outliers, such as glass backgrounds, slide marks, surgical inks, or tissue edges.

Using this method or another suitable method for determining the mean, the mean image of the collection of m tissue sample images of type A and spectral channel n is a scalar value. The pixel value may be, for example, a representation of the intensity or color information at each pixel. Other methods for determining the mean image may include feature-based averaging, dimensionality reduction techniques, or a pixel-wise calculation.

Likewise, the mean background of the collection of the m tissue sample images of type A and spectral channel n can be determined, given by:

ImageBG_{A}=Background(ImageA₁,ImageA₂,ImageA₃, . . . ,ImageAₘ).

In one example, the background may include dark frames or areas from the images of a slide, but other definitions of the background can be similarly used. The background calculation ImageBG_{A} thus involves determining the mean or median of the pixel values of the background dark frames or areas, for each respective spectral channel.

Similar aggregate images can be determined for the collection of p tissue sample images of type B and spectral channel n. These aggregate images can be represented as:

ImageMean_{B}=mean(ImageB₁,ImageB₂,ImageB₃, . . . ,ImageBₚ)

and

ImageBG_{B}=Background(ImageB₁,ImageB₂,ImageB₃, . . . ,ImageBₚ).

The normalization function F may then be given by:

$$F ( \text{} {Image}_{B} ) = \text{} ( {Image}_{B} - {Image BG}_{B} ) \cdot \frac{{ImageMean}_{A} - {ImageBG}_{A}}{{ImageMean}_{B} - {ImageBG}_{B}} + {ImageBG}_{A}$$

which can be rewritten in the functional form for F above as:

$$F ( {Image}_{B} ) = {C}_{A {B}_{1}} \cdot {Image}_{B} + {C}_{A {B}_{2}} where {C}_{A {B}_{1}} = \text{} \frac{{ImageMean}_{A} - {ImageBG}_{A}}{{ImageMean}_{B} - {ImageBG}_{B}} and {C}_{A {B}_{2}} = {ImageBG}_{A} - {C}_{A {B}_{1}} \cdot {ImageBG}_{B} .$$

Comparison of the virtual stain prediction 410 based on an unnormalized autofluorescence image with virtual stain prediction 450 based on a normalized autofluorescence image, as may be generated by the normalization component 260, illustrates the effect of the application of this example normalization procedure. These examples illustrate the effectiveness of the normalization step as well as the non-linearity of the modifications required to achieve the accuracy of the techniques of the present disclosure. For instance, manual methods such as manual tuning of color during post-processing of predicted virtual stains may not recover missing structural details (e.g., missing cell nuclei). Application of the techniques disclosure herein can ensure the predicted virtual stains include, for example, significantly more structural detail than can be recovered using manual tuning methods.

Numerous alternatives to the example normalization procedure described above may be used, particularly in examples with significant sample heterogeneity. For instance, where a single or small number of tissue sample images are used to compute the normalization coefficients, averaging the foreground or background over the entire tissue area to estimate an average autofluorescence spectrum may be unduly influenced by the impact of the tissue biopsy itself on various structural components or cell types, each of may express a different emitted spectrum.

To address these and similar challenges, several alternative approaches may be used in lieu of or in combination with the procedure described above. For example, an ML segmentation model can be used to locate and segment particular structural features (e.g., collagen) or cell types (e.g., hepatocytes) found in the tissue samples that are common to all tissue samples, irrespective of the procedure used to obtain the sample or other tissue sample properties.

An average spectrum of the identified collection of features can be determined, for each imaging channel. Normalization can then be performed by rescaling each imaging channel of the unnormalized input images to match the average spectrum for the respective imaging channel. A variation on this method can involve training the ML segmentation model to distinguish fluorescence intensities. After rescaling each imaging channel of the input images to match the average spectrum for the respective imaging channel, the ML segmentation model can be iteratively re-applied to determine a new average spectrum for each imaging channel. Iterative application of this method can result in convergence to an optimized average spectrum for each imaging channel.

Yet another variation on this method may involve determination of a rescaling matrix to be applied at each spatial location based on the average spectra determined for the imaging channels. The rescaling matrix may be a square N×N matrix in which N corresponds to the number of imaging channels. The normalization procedure can involve application of the rescaling matrix to unnormalized input images.

In one example, application of the rescaling matrix can be performed by first determining a set of M weights based on the reference spectrum for each imaging channel. The weights may correspond to, for example, different endogenous fluorophore concentrations. Each of the M weights can be multiplied by a different scalar, such that the average, adjusted fluorophore concentrations in the feature identified by the ML segmentation model match the endogenous fluorophore concentrations of the corresponding reference spectra, which are, in this case, average spectra. The endogenous fluorophore spectra can then be recombined into a final fluorescence spectrum by multiplying each of the M weights by the average spectrum associated with the corresponding endogenous fluorophore. In some examples, the rescaling matrix can be represented using matrix multiplication as S·C·P, in which Sis an N×M matrix, containing the reference spectra of the endogenous fluorophores as its columns, C is an M×M diagonal matrix, and P is an M×N projection matrix that relates the N imaging channels to the M weights.

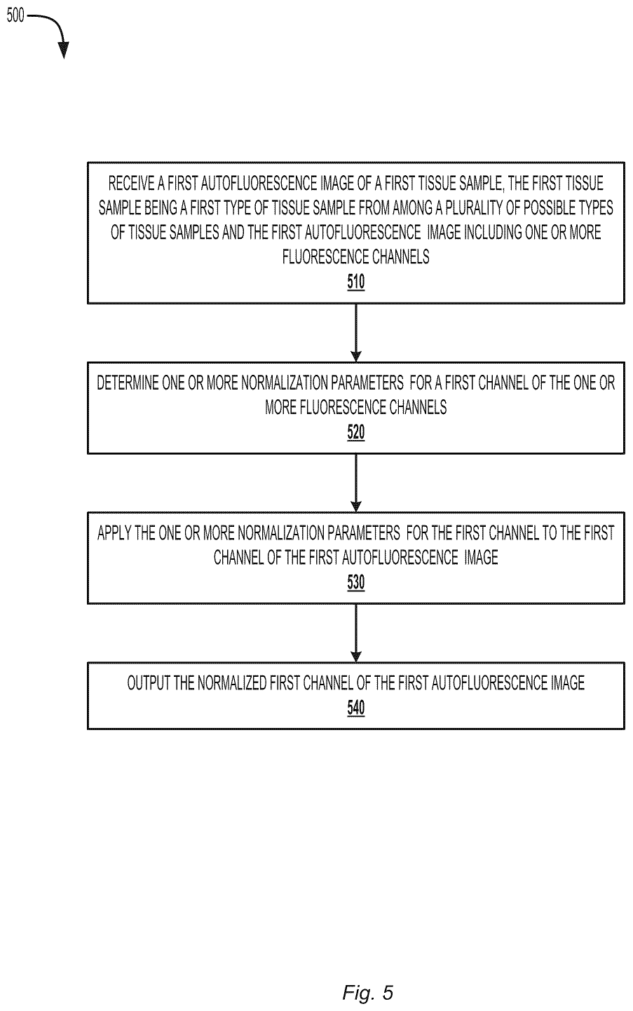

Referring now to FIG. 5, FIG. 5 shows an example method 500 illustrating image normalization for multispectral fluorescence microscopy and virtual staining during inference using, for example, the example system 300 of FIG. 3. In particular, the method 500 involves normalization parameters that correct for biases due to differing tissue sample types. The method 500 will be described with respect to the example system 100 shown in FIG. 1; however, any suitable system according to this disclosure may be used.

Method 500 may include block 510. At block 510, a computing device 110 receives a first autofluorescence image of a first tissue sample, in which the first tissue sample is a first type of tissue sample from among a number of possible types of tissue samples and the first autofluorescence image include one or more imaging channels. For example, the first tissue sample may be obtained from a patient via a biopsy procedure. The biopsy may be obtained for a microscopic assay such as examination of the first tissue sample to diagnose a disease, understand the extent of a disease, identify the nature of abnormal cells, determine candidacy for a treatment, and so on.

At block 520, the computing device 110 determines one or more normalization parameters for a first channel of the one or more imaging channels, in which the one or more normalization parameters for the first channel is based on a first relationship between the first type of tissue sample and a second type of tissue sample and the second type of tissue sample is a different type of tissue sample than the first type of tissue sample.

For example, the normalization parameters may be scalar coefficients that apply scaling or offset operations to the received images. In that example, the scalar coefficients can be computed using a method similar to the method described above with respect to FIGS. 4A and 4B. In that example, the scalar normalization coefficients are based on a relationship between aggregate measures of the images and background images of two tissue types. In some examples, other operations or objects may be used for normalization. For instance, the normalization parameters may include vectors, matrices, tensors, values from lookup tables, and so on. The normalization parameters may be functions of characteristics of the images such as pixel intensity distributions, color histograms, spatial frequencies, or external factors such as environmental factors, machine-dependent corrections, sensor outputs, among other possibilities.

At block 530, the computing device 110 applies the one or more normalization parameters for the first channel to the first channel of the first autofluorescence image. For instance, scalar coefficients may be applied by multiplying by or adding, as appropriate, to each pixel of the first channel of the first autofluorescence image. In some examples, the normalization parameters for each channel of the first autofluorescence image may be applied simultaneously, in parallel, such that a composite normalized image can be generated.

At block 540, the computing device 110 outputs the normalized first channel of the first autofluorescence image. For example, the normalized first channel of the first autofluorescence image can be input to an ML model configured for predicting a stained tissue sample images based on received images generated by autofluorescence. The ML model, such as ML model 280 described above with respect to FIG. 2, can determine a prediction of a stained tissue sample image based on the normalized imaging channels of the first autofluorescence image and output the prediction. The predicted image can be examined by a healthcare provider or by a computing system (e.g., another ML model) to make a determination about a pathology, treatment plan, research question, etc.

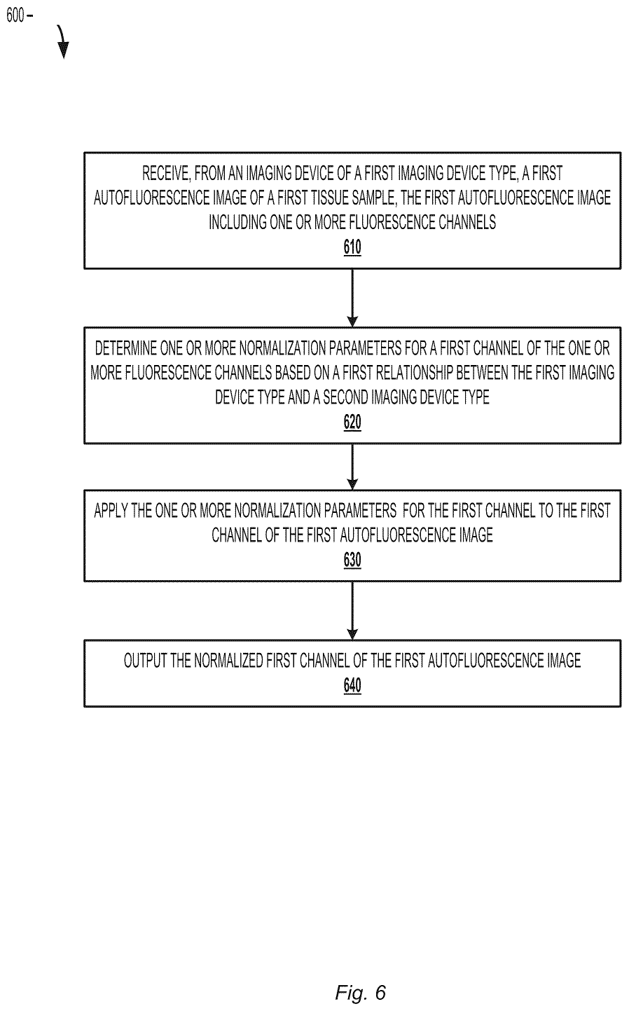

Referring now to FIG. 6, FIG. 6 shows an example method 600 illustrating image normalization for multispectral fluorescence microscopy and virtual staining during inference using, for example, the example system 300 of FIG. 3. In particular, the method 600 involves normalization parameters that correct for biases due to differing imaging device types. The method 600 will be described with respect to the example system 100 shown in FIG. 1; however, any suitable system according to this disclosure may be used.

Method 600 may include block 610. At block 610, a computing device 110 receives, from an imaging device of a first imaging device type, a first autofluorescence image of a first tissue sample, the first autofluorescence image including one or more imaging channels. As with block 510 above, the first tissue sample may be obtained from a patient via a biopsy procedure or the like. The biopsy may be obtained for a microscopic assay such as examination of the first tissue sample to diagnose a disease, understand the extent of a disease, identify the nature of abnormal cells, determine candidacy for a treatment, and so on.

As with tissue sample types, the ML model, such as ML model 280 described above with respect to FIG. 2, may be trained using one imaging device type while inference may be performed using a second imaging device type. Examples of imaging device types include transmission microscopes, epifluorescence microscopes, fluorescence lifetime imaging microscopes (FLIM), widefield fluorescence microscopes, or other types of fluorescence microscope.

The imaging device types are not limited to types of microscopes. For example, imaging device type may include types of components of microscopes (e.g., LED sources or cameras), environmental constraints (e.g., microscopes used with or without vacuum), machine age or condition, and so on. In some examples, imaging device type may refer to specific imaging devices. For instance, a first imaging device type may be an epifluorescence microscope of a particular make and model, while a second imaging device may be a different epifluorescence microscope of a the same make and model.

At block 620, the computing device 110 determines one or more normalization parameters for a first channel of the one or more imaging channels, in which the one or more normalization parameters for the first channel are based on a first relationship between the first imaging device type and a second imaging device type, in which the second imaging device type is different from the first imaging device type. Similar to the process described with respect to FIGS. 4A and 4B above, the normalization parameters can be determined through selection of a relationship between the imaging devices used during training and inference, respectively. For example, in addition to the example approach of FIGS. 4A and 4B involving converging to the mean image and mean background image, image characteristics such as the intensity distribution, color histograms, noise patterns, dynamic range, and so on, can be used to determine relationships for the computation of normalization parameters.

At block 630, the computing device 110 applies the one or more normalization parameters for the first channel to the first channel of the first autofluorescence image. As with block 530 above, the normalization parameters can be applied to the first autofluorescence image using a suitable technique. For instance, scalars can multiply or add to pixel values. Vectors may require operations such as element-wise multiplication or addition with pixel values. The particular method used to apply the normalization parameters to the first autofluorescence image can vary according to both the form of the normalization parameters (e.g., scalar, vector, etc.) as well as the method used to compute the normalization parameters. For instance, different functional forms can be used for application of the normalization parameters involving operations such as multiplication, addition, exponentiation, trigonometric functions, logarithmic functions, and so on.

At block 640, the computing device 110 outputs the normalized first channel of the first autofluorescence image. For example, the normalized first channel of the first autofluorescence image can be input to an ML model configured for predicting a stained tissue sample images based on received images generated by autofluorescence. The ML model, such as ML model 280 described above with respect to FIG. 2, can determine a prediction of a stained tissue sample image based on the normalized imaging channels of the first autofluorescence image and output the prediction. The predicted image can be examined by a healthcare provider or by a computing system (e.g., another ML model) to make a determination about a pathology, treatment plan, research question, etc. The ML model 280 can be trained using training tissue sample images that are generated by the second imaging device type of block 620.

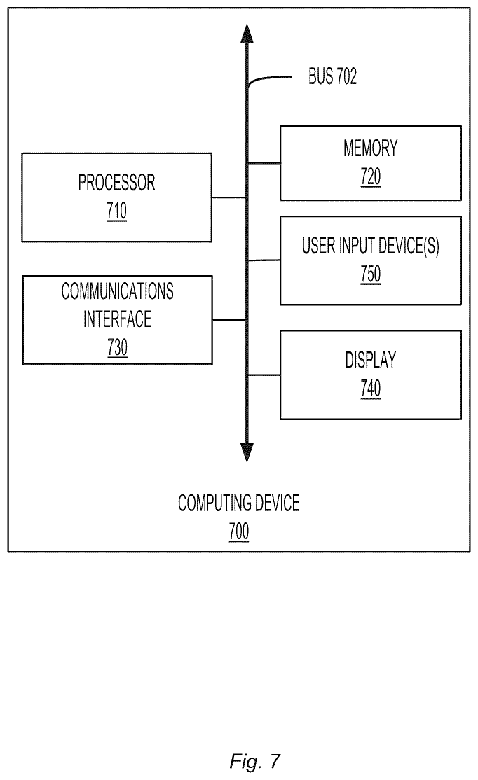

Referring now to FIG. 7, FIG. 7 shows an example computing device 700 suitable for use in example systems or methods for image normalization for multispectral fluorescence microscopy and virtual staining according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for training ML models or generating virtually stained images according to different examples, such as part or all of the example methods 500 or 600 described above with respect to FIG. 5 or FIG. 6. The computing device 700 also includes one or more user input devices 750, such as a keyboard, mouse, touchscreen, microphone, etc., to accept user input; however, in some examples, the computing device 700 may lack such user input devices, such as remote servers or cloud servers. The computing device 700 also includes a display 740 to provide visual output to a user.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method, comprising:
receiving, from an imaging device of a first imaging device type, a first autofluorescence image of a first tissue sample, the first autofluorescence image comprising one or more imaging channels;
determining one or more normalization parameters for a first channel of the one or more imaging channels, the one or more normalization parameters for the first channel based on a first relationship between the first imaging device type and a second imaging device type, the second imaging device type being different from the first imaging device type;
applying the one or more normalization parameters for the first channel to the first channel of the first autofluorescence image; and
outputting the normalized first channel of the first autofluorescence image.

2. The method of claim 1, further comprising:
determining, using a machine learning model, a prediction of a stained tissue sample image based on one or more normalized imaging channels of the first autofluorescence image; and
outputting the prediction of the stained tissue sample image.

3. The method of claim 2, wherein the machine learning model is trained using a plurality of training tissue sample images, wherein each tissue sample image of the plurality of training tissue sample images is generated by the second imaging device type.

4. The method of claim 3, wherein the plurality of training tissue sample images are stained tissue samples.

5. The method of claim 4, wherein the plurality of training tissue sample images comprise:
autofluorescence images of one or more tissue samples generated by the second imaging device type, wherein the autofluorescence images are obtained when the one or more tissue samples generated by the second imaging device type are unstained; and
images of the one or more tissue samples generated by the second imaging device type, wherein the images are obtained when the one or more tissue samples generated by the second imaging device type are stained.

6. The method of claim 1, wherein a machine learning model is trained using a plurality of normalized autofluorescence imaging channels of tissue sample images including the normalized first channel of the first autofluorescence image, each channel normalized using first normalization parameters based on a second relationship between the first imaging device type and the second imaging device type, the second imaging device type being different from the first imaging device type and further comprising:
receiving a second autofluorescence image of a second tissue sample, wherein:
the second autofluorescence image is generated by a second imaging device having the second imaging device type; and
the second autofluorescence image comprises the one or more imaging channels;
determining, using the machine learning model, a first prediction of a first stained tissue sample image based on the one or more normalized imaging channels of the second autofluorescence image; and
outputting the first prediction of the first stained tissue sample image.

7. The method of claim 6, further comprising:
receiving a third autofluorescence image of a third tissue sample, wherein:
the third autofluorescence image is generated by a third imaging device having the second imaging device type; and
the third autofluorescence image comprises the one or more imaging channels;
determining one or more normalization parameters for a third channel of the one or more imaging channels, the one or more normalization parameters for the third channel based on a third relationship between the first imaging device type and the second imaging device type, the second imaging device type being different from the first imaging device type;
applying the one or more normalization parameters for the third channel to the third channel of the third autofluorescence image; and
determining, using the machine learning model, a second prediction of a second stained tissue sample image based on the one or more normalized imaging channels of the first autofluorescence image; and
outputting the second prediction of the second stained tissue sample image.

8. A system comprising:
a non-transitory computer-readable medium;
one or more processors in communication with the non-transitory computer-readable medium, the one or more processors configured to execute processor-executable instructions stored in the non-transitory computer-readable medium configured to cause the one or more processors to:
receive, from a first imaging device type, a first autofluorescence image of a first tissue sample, the first autofluorescence image comprising one or more imaging channels;
determine one or more normalization parameters for a first channel of the one or more imaging channels, the one or more normalization parameters for the first channel based on a first relationship between the first imaging device type and a second imaging device type, the second imaging device type being different from the first imaging device type;
apply the one or more normalization parameters for the first channel to the first channel of the first autofluorescence image; and
output the normalized first channel of the first autofluorescence image.

9. The system of claim 8, further comprising:
determining, using a machine learning model, a prediction of a stained tissue sample image based on one or more normalized imaging channels of the first autofluorescence image; and
outputting the prediction of the stained tissue sample image.

10. The system of claim 9, wherein the machine learning model is trained using a plurality of training tissue sample images, wherein each tissue sample image of the plurality of training tissue sample images is generated by the second imaging device type.

11. The system of claim 10, wherein the plurality of training tissue sample images are stained tissue samples.

12. The system of claim 11, wherein the plurality of training tissue sample images comprise:
autofluorescence images of one or more tissue samples generated by the second imaging device type, wherein the autofluorescence images are obtained when the one or more tissue samples generated by the second imaging device type are unstained; and
images of the one or more tissue samples generated by the second imaging device type, wherein the images are obtained when the one or more tissue samples generated by the second imaging device type are stained.

13. The system of claim 8, wherein a machine learning model is trained using a plurality of normalized training imaging channels of tissue sample images including the normalized first channel of the first autofluorescence image, each training channel normalized using first normalization parameters for the first channel based on a second relationship between the first imaging device type and the second imaging device type, the second imaging device type being different from the first imaging device type and further comprising:
receiving a second autofluorescence image of a second tissue sample, wherein:
the second autofluorescence image is generated by the second imaging device type; and
the second autofluorescence image comprises the one or more imaging channels;
determining, using the machine learning model, a first prediction of first a stained tissue sample image based the normalized one or more imaging channels of the second autofluorescence image; and
outputting the first prediction of the first stained tissue sample image.

14. The system of claim 13, further comprising:
receiving a third autofluorescence image of a third tissue sample, wherein:
the third autofluorescence image is generated by the second imaging device type; and
the third autofluorescence image comprises the one or more imaging channels;
determining one or more normalization parameters for a third channel of the one or more imaging channels, the one or more normalization parameters for the third channel based on a third relationship between the first imaging device type and the second imaging device type, the second imaging device type being different from the first imaging device type;
applying the one or more normalization parameters for the third channel to the third channel of the third autofluorescence image; and
determining, using the machine learning model, a second prediction of a second stained tissue sample image based on the normalized one or more imaging channels of the first autofluorescence image; and
outputting the second prediction of the second stained tissue sample image.

15. A non-transitory computer-readable medium comprising processor-executable instructions configured to cause one or more processors to:
receive, from a first imaging device type, a first autofluorescence image of a first tissue sample, the first autofluorescence image comprising one or more imaging channels;
determine one or more normalization parameters for a first channel of the one or more imaging channels, the one or more normalization parameters for the first channel based on a first relationship between the first imaging device type and a second imaging device type, the second imaging device type being different from the first imaging device type;
apply the one or more normalization parameters for the first channel to the first channel of the first autofluorescence image; and
output the normalized first channel of the first autofluorescence image.

16. The non-transitory computer-readable medium of claim 15, further comprising:
determining, using a machine learning model, a prediction of a stained tissue sample image based on one or more normalized imaging channels of the first autofluorescence image; and
outputting the prediction of the stained tissue sample image.

17. The non-transitory computer-readable medium of claim 16, wherein the machine learning model is trained using a plurality of training tissue sample images, wherein each tissue sample image of the plurality of training tissue sample images is generated by the second imaging device type.

18. The non-transitory computer-readable medium of claim 17, wherein the plurality of training tissue sample images are stained tissue samples.

19. The non-transitory computer-readable medium of claim 15, wherein a machine learning model is trained using a plurality of normalized training imaging channels of tissue sample images including the normalized first channel of the first autofluorescence image, each training channel normalized using first normalization parameters for the first channel based on a second relationship between the first imaging device type and the second imaging device type, the second imaging device type being different from the first imaging device type and further comprising:
receiving a second autofluorescence image of a second tissue sample, wherein:
the second autofluorescence image is generated by the second imaging device type; and
the second autofluorescence image comprises the one or more imaging channels;
determining, using the machine learning model, a first prediction of a first stained tissue sample image based on the one or more normalized imaging channels of the second autofluorescence image; and
outputting the first prediction of the first stained tissue sample image.

20. The non-transitory computer-readable medium of claim 19, further comprising:
receiving a third autofluorescence image of a third tissue sample, wherein:
the third autofluorescence image is generated by the second imaging device type; and
the third autofluorescence image comprises the one or more imaging channels;
determining one or more normalization parameters for a third channel of the one or more imaging channels, the one or more normalization parameters for the third channel based on a third relationship between the first imaging device type and the second imaging device type, the second imaging device type being different from the first imaging device type;
applying the one or more normalization parameters for the third channel to the third channel of the third autofluorescence image; and
determining, using the machine learning model, a second prediction of a second stained tissue sample image based on the one or more normalized imaging channels of the first autofluorescence image; and
outputting the second prediction of the second stained tissue sample image.
